(19) United States
(12) Patent Application Publication
(10) Pub. No.: US 2009/0291637 A1
(43) Pub. Date: Nov. 26, 2009

(54) SECURE WIRELESS COMMUNICATION INITIALIZATION SYSTEM AND METHOD

(75) Inventors: Ansaf I. ALRABADY, Livonia, MI (US); Alan T. BUDYTA, Grand Blanc, MI (US); Jason D. YORK, Nolensville, TN (US); Richard C. VANITVELT, Metamora, MI (US)

Correspondence Address: INGRASSIA FISHER & LORENZ, P.C. (GM), 7010 E. COCHISE ROAD, SCOTTSDALE, AZ, 85253, US

(73) Assignee: GM GLOBAL TECHNOLOGY OPERATIONS, INC., DETROIT, MI (US)

(21) Appl. No.: 12/124,428

(22) Filed: May 21, 2008

(51) Int. Cl. H04B 7/00

(52) U.S. Cl. 455/41.2

(57) ABSTRACT

A wireless communication system for a vehicle is provided. The system comprises a portable wireless device comprising first and second manual interface devices and adapted to transmit a wireless network security protocol confirmation signal in response to manipulation of the first and second manual interface devices, and an onboard wireless communication device for the vehicle, adapted to accept a Wi-Fi Protected Setup (WPS) session outcome in response to receiving the wireless network security protocol confirmation signal.

### TECHNICAL FIELD

Embodiments of the subject matter described herein relate generally to secure wireless communication. More particularly, embodiments of the subject matter relate to initializing communication between components of a wireless system to permit secure communications therebetween.

### BACKGROUND

Vehicles, including automobiles, are being configured to interface with remote computing systems to a greater degree. To interface with remote computer systems, a network connection is usually established between the vehicle and the computer. Preferably, such a connection is established using a wireless network adapter, removing the need for a physical coupling between the vehicle and some portion of a network infrastructure.

Because transmission of information through a wireless network requires broadcast of the information, the possibility of unwanted observation of the transmitted information is an inherent risk in any wireless network. To mitigate and minimize such risk, communication over a wireless network can be encrypted, significantly reducing the likelihood an observer can decipher and understand the information being passed between systems communicating over the network. Additionally, such encryption can make it difficult for a third party to participate in the network, despite being able to broadcast information conforming to the network protocol.

To establish encryption between two participants in a wireless network, some initialization information is usually exchanged between them, such as key information. With exchanged key information, participants in a wireless network can communicate through an encrypted channel. Securely exchanging key information between participants in a wireless network can be cumbersome to do simply.

### BRIEF SUMMARY

An apparatus is provided for a wireless communication system for a vehicle. The system can comprise a portable wireless device comprising first and second manual interface devices and adapted to transmit a wireless network security protocol confirmation signal in response to manipulation of the first and second manual interface devices and an onboard wireless communication device for the vehicle, adapted to accept a Wi-Fi Protected Setup (WPS) session outcome in response to receiving the wireless network security protocol confirmation signal.

A method of confirming establishment of secure wireless network communication between a vehicle and a wireless access point. The method can comprise receiving a wireless network security protocol confirmation signal at the vehicle from a key fob associated with the vehicle, and accepting an outcome of a Wi-Fi Protected Setup (WPS) session between the vehicle and the wireless access point at the vehicle in response to receiving the wireless network security protocol confirmation signal.

Another method of establishing secure wireless communication between a vehicle and a wireless access point is provided. The method comprises receiving an activation signal at the vehicle, transmitting a wireless network security protocol initiation signal from the vehicle in response to the activation signal, performing a wireless network security protocol session from the vehicle in response to a wireless network security protocol response signal from the wireless access point, operating a feedback device of the vehicle after completion of the wireless network security protocol session, and retaining the outcome of the wireless network security protocol session in response to receiving a confirmation signal from a key fob associated with the vehicle.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a schematic illustration of an embodiment of a secure wireless communication system and method of operation;

FIG. 2 is a schematic illustration of another embodiment of a secure wireless communication system and method of operation; and

FIG. 3 is a diagram that illustrates communication of wireless signals for an embodiment of a secure wireless communication system.

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

Techniques and technologies may be described herein in terms of functional and/or logical block components and with reference to symbolic representations of operations, processing tasks, and functions that may be performed by various computing components or devices. It should be appreciated that the various block components shown in the figures may be realized by any number of hardware, software, and/or firmware components configured to perform the specified functions. For example, an embodiment of a control system or computing system or any component thereof may employ various integrated circuit components, e.g., memory elements, digital signal processing elements, logic elements, look-up tables, or the like, which may carry out a variety of functions under the control of one or more microprocessors or other control devices.

When implemented in software or firmware, various elements of the systems described herein are essentially the code segments or instructions that perform the various tasks. The program or code segments can be stored in a processor-readable medium or transmitted by a computer data signal embodied in a carrier wave over a transmission medium or communication path. The computer data signal may include any signal that can propagate over a transmission medium such as electronic network channels, optical fibers, air, electromagnetic paths, or RF links, including wireless networks conforming to certain Institute of Electrical and Electronics Engineers (IEEE), among others.

“Node/Port”—As used herein, a “node” means any internal or external reference point, connection point, junction, signal line, conductive element, or the like. Furthermore, two or more nodes may be realized by one physical element (and two or more signals can be multiplexed, modulated, or otherwise distinguished even though received or output at a common mode). “Node” can also refer to a member of a wireless network, such as an access point, or computer system communicating with other members of the wireless network with a wireless adapted and/or transceiver. When used in the context of a wireless network, a participant in a wireless network can be a node in the wireless network.

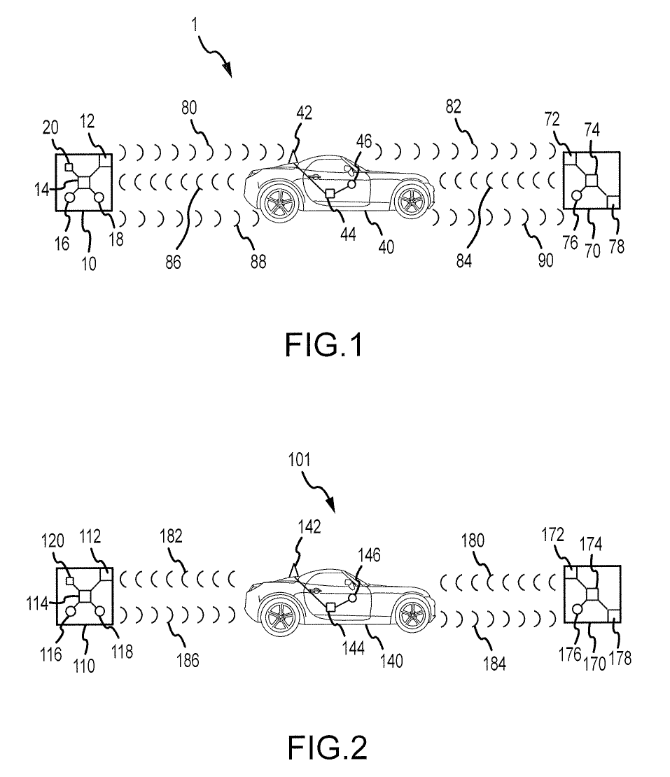

“Connected/Coupled”—The following description refers to elements or nodes or features being “connected” or “coupled” together. As used herein, unless expressly stated otherwise, “connected” means that one element/node/feature is directly joined to (or directly communicates with) another element/node/feature, and not necessarily mechanically. Likewise, unless expressly stated otherwise, “coupled” means that one element/node/feature is directly or indirectly joined to (or directly or indirectly communicates with) another element/node/feature, and not necessarily mechanically. Thus, although the schematic shown in FIG. 1 depicts one exemplary arrangement of elements, additional intervening elements, devices, features, or components may be present in an embodiment of the depicted subject matter.

The terms “first”, “second” and other such numerical terms referring to structures do not imply a sequence or order unless clearly indicated by the context.

For the sake of brevity, conventional techniques related to signal processing, data transmission, signaling, network control, network setup, encryption, including public key encryption, and other functional aspects of the systems (and the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in an embodiment of the subject matter.

FIG. 1 illustrates a wireless communication system 1 comprising, among other possible elements, a key fob 10, a vehicle 40, and a wireless access point 70. Typically, the key fob 10 can be operated by a user to control various features of the vehicle 40, such as unlocking doors, unlatching the trunk, or changing the operational state of a theft deterrent system. The vehicle 40 can be adapted to wirelessly communicate with the wireless access point 70 to enable an exchange of communication of the sort, and for the purpose, described above.

The key fob 10 preferably comprises a first wireless transceiver 12, a first control system 14, a first manual interface device 16, a second manual interface device 18, and a first feedback device 20. The first wireless transceiver 12 can be coupled to the first control system 14. The first control system 14 can be coupled to the first and second manual interface devices 16, 18. The first control system 14 can also be coupled to the first feedback device 20. In certain embodiments, other features, such as additional manual interface devices and/or feedback devices can also be present. Certain embodiments of the key fob 10 can comprise additional or fewer components and/or features, such as panic buttons, lights, and the like.

The first wireless transceiver 12 can be adapted to transmit and receive wireless signals in any of a variety of methods, such as infrared, radiofrequency (RF), or other portions of the electromagnetic spectrum, including the use of spread-spectrum technology. Certain embodiments of the transceivers as described throughout can comprise elements that are capable of receiving wireless signals as well as transmitting them. In some embodiments, a transceiver can be capable of only transmitting, while in others, it can only receive and, in still others, it can both transmit and receive wireless signals. In some embodiments, the first control system 14 can transmit and receive information through the first wireless transceiver 12. Such conveyance of information can conform to applicable standards, protocols, and constraints as practiced in the art.

The first control system 14 can be coupled to the other recited components of the key fob 10, allowing exchange of information to and from such components. Additionally, the first control system 14 can include or cooperate with a memory module, a power source, such as a battery or electrical supply from another module, and/or a microprocessor. Typically, such components are selected as suitable to enable the control system to interpret requests and commands from various components of the system 1 and respond, issue responses, and/or operate various components to produce the desired response, as suitable to operation in the system 1. Some non-limiting examples of such behavior can include initiation of transmissions using the first wireless transceiver 12 in response to manipulation of the first and/or second manual interface devices 16, 18, operation of the first feedback device 20 in response to the reception of a signal by the first wireless transceiver 12, and operation of the first feedback device 20 in response to manipulation of the manual interface devices 16, 18, or any combination thereof.

The first and second manual interface devices 16, 18 can comprise any of a number of mechanisms for permitted manual manipulation to cause input to the first control system 14. Such input can prompt, among other things, the first control system 14 to cause the first wireless transceiver 12 to transmit or broadcast a wireless signal. In some embodiments, such wireless signals can convey requests to a vehicle for, among other things, the unlocking of doors and/or hatches of a vehicle, unlatching of the trunk, and the like. Some types of devices suitable to serve as a manual interface device can include buttons, knobs, touch-sensitive graphic displays, and the like. In at least one embodiment, an elastomeric button, such as one constructed from rubber, silicone, or other flexible plastic, can be used.

Manipulation of a manual interface device or manual input device, such as the first and second manual interface devices 16, 18, can be performed in a variety of modes. Each interface device can comprise one or more separate mechanisms, such as buttons. In some modes, a single interface device can be pressed and held in an activated or engaged position for a specified period of time, such as at least a half second, a whole second, or multiple seconds. In others, both devices can be pressed substantially simultaneously. In certain modes, one interface device can be pressed and held in an activated position while the second interface device is pressed, then released. In some modes, the interface devices can be activated or engaged in a specific sequence, including alternating between the devices, either a single time or repetitiously, with different combinations of activations. Other modes can include manipulating one or more of the devices within a predetermined time interval of another, or manipulating one or more devices until a feedback device of the key fob is triggered. Other permutations and combinations of operational modes are also contemplated.

The first feedback device 20 can be a single mechanism or comprise a number of individual mechanisms, such as a visual feedback mechanism, an audible feedback mechanism, or a haptic feedback mechanism. The first feedback device 20 can be operated by the first control system 14 to produce or emit any of a variety of feedback modes. Some non-limiting examples of feedback modes can include a blinking light, an audible tone, a vibrating or buzzing sensation, a solid light, and intermittent beeping sound, a graphic or textual display, and any combination thereof, including patterns and sequences. Such feedback can convey responses to operations of the system or a status of one or more portions of the system, device, or vehicle, as appropriate to the circumstances and as operated by the first control system 14.

The vehicle 40 can comprise, among many other devices, mechanisms, and components, a second wireless transceiver 42, a second control system 44, and a third manual interface device 46. The vehicle 40 can be an automobile or other vehicle, such as a pick-up truck, sport utility vehicle, motorcycle, or watercraft. The illustrated elements of vehicle 40 can comprise individual components or they can be integrated with other components. As an example, the second wireless transceiver 42 can be integrally formed with a satellite radio antenna, though other combinations are possible. Similarly, the second control system 44 can be adapted to control various other portions of the vehicle 40, such as engine operations, audio entertainment control, fuel tracking and mileage estimation, among others. In some embodiments, the second control system 44 can be configured to perform a vehicular operation in response to receiving a wireless signal from the key fob 10.

The second control system 44 can also cooperate with other systems of the vehicle 40, such as the electrical system, a separate computing and data storage system, the HVAC system, a Global Positioning System, and so on. In at least one embodiment, the second control system 44 can be coupled to the second wireless transceiver 42, adapted to act as a wireless interface for other systems or components of the vehicle. As one non-limiting example, the second control system 44 and second wireless transceiver 42 can communicate information wirelessly between the vehicle's computing and/or data storage system and a remote wireless device such as 10. As another non-limiting example, the second wireless transceiver 42 can be adapted to receive a wireless signal conveying a request or command to unlock the vehicle's doors. In response, the second control system 44 can perform the operation. Such operations, also including activation or deactivation of a vehicle's theft prevention system, the operation of powered glass, such as opening or closing passenger windows, the unlatching and/or raising of a trunk, and the like can be considered vehicular operations, and many others are possible.

The second control system 44 can communicate wirelessly with the second wireless transceiver 42, including participating in a wireless network with other wirelessly-communicating devices. As described in greater detail below, the vehicle 40 can interact with other wirelessly-communicating devices using the second wireless transceiver 42, including through an encrypted communications channel. As one non-limiting example, some components of the vehicle 40, such as a computing system, can communicate with remote computing systems using the second wireless transceiver 42 in cooperation with the second control system 44. In some embodiments, the second control system 44 can be integrally formed with such a computing system. The second control system 44 can additionally be coupled to the third manual interface device 46, similar to those described above.

The wireless access point 70 can comprise, among other components, a third wireless transceiver 72, a third control system 74, a fourth manual interface device 76, and a second feedback device 78. The wireless access point 70 can comprise the third wireless transceiver 72 coupled to the third control system 74, the fourth manual interface device 76, which can be similar to the first and second manual interface devices 16, 18, and the second feedback device 78, which can be similar to the first feedback device 20. The second feedback device 78 can be operable by the third control system 74. As with the first and second control systems 14, 44, the third control system 74 can comprise or be integrally formed with various other electronic components, such as a network adapter, an interface bus, various types of digital data storage, and the like. The third control system 74 can be adapted to communicate through the third wireless transceiver 72 in any suitable protocol and conforming to appropriate standards. In one non-limiting embodiment, the wireless access point 70 can interact with other wireless network devices, such as the second wireless transceiver 42 and vehicle 40 using IEEE standards, such as 802.11(b), 802.11(g), 802.11(n), among other standards. The wireless access point 70 can additionally communicate with other networkable computing systems, both wirelessly and, in certain embodiments, through a physical coupling, such as through a node or port complying to the Ethernet standard, IEEE 802.3.

In some embodiments, the wireless access point 70 can be adapted to communicate through an encrypted channel. Such encryption can be accomplished through any suitable scheme, including public key cryptography, the use of which is well-known in the art, as well as other methods, including the use of public key cryptography in a network security protocol, such as Wi-Fi Protected Access (WPA) and WPA2. Accordingly, the wireless access point 70 can comprise suitable components and/or configuration to encrypt and decrypt information wirelessly transmitted and received while participating in a wireless network.

To practice public key encryption, a system requires at least its own public and private keys—known as a key pair—as well as a public key that corresponds to an intended participant in the encrypted communication channel. Such keys can be generated and exchanged using a known system, such as the Diffie-Hellman key exchange protocol. Thus, the wireless access point 70 can store and retrieve for use its own key pair, as well as the public keys of other wireless devices between which communication is desired, such as the vehicle 40. Similarly, the vehicle 40 can store and retrieve its own key pair, as well as public keys of other devices, such as the wireless access point 70. When a vehicle first encounters a wireless access point, however, neither the vehicle nor the access point is likely to already have the other's public key, among other pieces of identifying information. Accordingly, it is advantageous to establish a method of key and information exchange that enables each wireless network participant to securely communicate with the other.

One method of exchanging public key and identifying information can be manual entry into each wireless device of the other's information, or a shared secure string of numbers or letters used to facilitate secure exchange. In some circumstances, such as where a vehicle is desired to be a wireless network participant, manual entry of a long alphanumeric string can be inconvenient and provide an obstacle to easy communication between the vehicle and other devices, such as the wireless access point.

Some devices can use the Wireless Protected Setup (WPS) standard to initiate contact and exchange information prior to participation in a secure wireless network. Other devices can use different wireless network security protocols, which can include those which exchange network security information through entry of such information into individual devices, or transmission of a shared secret prior to secure communication. In one practice of the WPS standard, a first device can transmit a WPS initiation signal, conveying a request to join a secure wireless network. A registrar of the secure wireless network can transmit a WPS response signal in response to reception of the WPS initiation signal. The content of the WPS initiation and WPS response signals can conform to the WPS standard and subsequent signals can be sent by either device to continue and/or complete the enrollment of the first device into the secure wireless network. The WPS initiation signal can convey information suitable to the WPS standard to initiate the enrollment process of the first device and the WPS response signal can conform to the WPS standard in responding to the initiation signal.

To remove the undesirable and inconvenient task of entering a long alphanumeric string, some embodiments of wireless devices can practice the WPS standard through a method known as Push Button Configuration (PBC). In PBC, a physical input, such as a button, is manipulated on both devices to initiate a WPS session and respond to a WPS initiation signal. Thus, in one embodiment, a user can press a button on a wireless device to transmit a WPS setup or initiation signal, and a wireless access point can receive the signal. A user can then manipulate a button or other input device on the wireless access point before a certain period of time has passed, in accordance with the WPS PBC specification, to transmit a valid response to the WPS initiation signal. Because of the physical interaction, timing requirements, and user attention, it is unlikely a wireless access point will be prompted to respond to unwanted WPS initiation requests. In the case where a vehicle is establishing a secure network connection with an access point, it can be inconvenient to press both buttons within the allotted time period, especially when one is coupled to the vehicle and the other is coupled to the wireless access point.

Thus, using the system 1, a user can manipulate at least one of the first and second manual input devices 16, 18 of the key fob 10 to transmit an activation signal 80 with the first wireless transceiver 12 of the key fob 10. Such manipulation can be any of the modes described above. The activation signal 80 can convey a request or command to the vehicle 40 indicating the user's desire to have the vehicle 40 transmit a WPS initiation signal 82. Thus, the vehicle 40 can transmit the WPS initiation signal 82 in response to receiving the activation signal 80 from the key fob 10.

In the depicted embodiment, the wireless access point 70 receives the WPS initiation signal 82. In response, the wireless access point 70 can perform or direct another component to perform one or more steps specified in the WPS standard for establishing secure communication with a mobile device, in this case, the vehicle 40. Additionally, the wireless access point 70 can operate its second feedback device 78 to inform a nearby user that the wireless access point 70 has received a WPS initiation signal 82.

A user can then manipulate the fourth manual interface device 76 of the wireless access point 70, indicating a request or command to proceed with the WPS procedure to establish secure communication with the device from which the WPS initiation signal 82 was received. In response, the wireless access point 70 can transmit a WPS response signal 84. The vehicle 40, after receiving the WPS response signal 84, can transmit another signal to the key fob 10 indicating the successful establishment of contact with the wireless access point 70. This signal, the acknowledgement signal 86, can be transmitted by the vehicle 40 and received by the key fob 10.

In response to the acknowledgement signal 86, the key fob 10 can operate the first feedback device 20. Accordingly, a user can be informed as to the success or failure of the activation 80 and/or WPS initiation 82 signals through different modes of operation of the first feedback device 20. Thus, a user can convey commands to the vehicle 40 remotely, removing the need for manual operation of one or more devices coupled to the vehicle 40 to establish the vehicle as a participant in a wireless network using WPS activation. Advantageously, a user within reach of the wireless access point 70 can use the key fob 10 to establish secure wireless communication between the wireless access point 70 and the vehicle 40. In some embodiments, the third manual interface device 46 of the vehicle 40 can additionally be used to perform some operations of the key fob 10, such as replacing the activation signal 80, allowing a user to begin the WPS procedure from within the vehicle 40, if desired.

In some embodiments, the vehicle 40 can maintain the wireless transceiver 42 in a low-power mode, or not provide power at all, to conserve use of the battery or other electrical power storage device of the vehicle. Upon receiving the activation signal 80, however, the vehicle 40 can provide power to its wireless transceiver 42 in response, thereby enabling wireless communication between the vehicle 40 and remote sources, such as the wireless access point 70.

Because the wireless signals sent by both the vehicle 40 and the wireless access point 70 can be broadcast into the nearby vicinity of the devices, it is possible for the vehicle 40 to respond to, or initiate communicate with, a different wireless access point than that with which the user intends to establish a secure wireless network. Such an unintended wireless access point can be called a foreign wireless access point.

A vehicle can inadvertently establish a connection with a foreign wireless access point in two ways. First, when the vehicle transmits a WPS initiation signal 82, the foreign wireless access point can respond with a WPS response signal 84. If the foreign wireless access point has stronger signal strength, as received by the vehicle, than the intended wireless access point, the vehicle may prefer the foreign wireless access point for purposes of continuing the WPS session. Alternatively, the vehicle 40 can receive a WPS initiation signal from a foreign wireless access point during a period when its wireless transceiver 42 is in full-power mode. Preferably, the user can indicate to the vehicle 40 when it is in contact with the intended wireless access point 70, and not a foreign wireless access point.

Thus, in some embodiments, the key fob 10 can be further adapted to transmit a wireless network security protocol confirmation signal 88 after manipulation by a user. The confirmation signal 88 need not be a WPS-specific signal, and can conform to any suitable protocol for information exchange, as with the activation signal 80.

The confirmation signal 88 can convey to the vehicle 40 that continuation and/or completion of the WPS session is desirable. Preferably, the user can use the first and second manual interface devices 16, 18, either alone or in combination, to transmit the confirmation signal 88. Accidental or random transmission of the confirmation signal 88 can be prevented or minimized by configuring the key fob 10 to only respond to a predetermined sequence or pattern of manipulation of the manual interface devices 16, 18.

The key fob 10 can be configured to operate the first feedback device 20 in response to receiving the acknowledgement signal 86, indicating a suitable time for transmission of the confirmation signal 88. Thus, the key fob 10 can provide feedback of the occurrence of a step in the WPS session at which further input from the vehicle is required, such as transmission of the confirmation signal 88. The confirmation signal 88 can be sent independent of the reception of the acknowledgement signal 86, and is not dependent on receiving communication from the vehicle 40.

In certain embodiments, the wireless access point 70 can provide feedback using its second feedback device 78 to convey to the user the device(s) with which the wireless access point 70 is in wireless communication. In some embodiments, such feedback is provided through cooperation with another device, such as a networked computer (not shown). A user can therefore confirm that the vehicle 40 is wirelessly communicating with the intended wireless access point 70, and not a foreign wireless access point. Preferably, the user can thereafter transmit the confirmation signal 88 from the key fob 40, enabling continuation of the WPS session.

In response to receiving the confirmation signal 88, the vehicle 40 can transmit a WPS continuation signal 90. The WPS continuation signal 90 is preferably the next sequence in the WPS session, following reception of the WPS response signal 84, which permits the WPS session to continue or complete.

In some embodiments, the confirmation signal 88 is not required to continue the WPS session. After receiving the activation signal 80, the vehicle 40 can undertake and complete a WPS session with the access point 70. In some embodiments, only after the WPS session is complete can feedback be provided to the user, through any of the feedback devices of the key fob 10, vehicle 40, and/or access point 70. After determining from the feedback that the vehicle 40 has performed a WPS session with the correct access point, the user can transmit the confirmation signal 88 from the key fob 10. As a response to the confirmation signal 88, the vehicle 40 can accept the WPS session conclusion as valid, desired by the user, save the result, and implement the resulting exchanged security credentials in future wireless communication between the vehicle 40 and the access point 70. Preferably, the security credentials are maintained within a data storage device of the vehicle and available for future retrieval.

As illustrated in FIG. 2, in some embodiments, the wireless access point 170 can initiate the WPS procedure, transmitting a WPS initiation signal 180 which can be received by nearby wireless devices, such as the vehicle 140. Unless otherwise specified, components in FIG. 2 are similar to those in FIG. 1, except that the number designating the component has been incremented by 100. Under such circumstances, devices already participating in the secure wireless network with the wireless access point can ignore the signal, while a wireless device not already participating, such as the vehicle 140, can begin participating in the network after completing the WPS procedure. Additionally, in certain embodiments, the vehicle 140 can activate its wireless transceiver, either in response to a signal from the key fob 110 or in response to other input, such as manipulation of the third manual interface device 46.

Accordingly, a user can manipulate the fourth manual interface device 176 to cause the wireless access point 170 to transmit a WPS initiation signal 180. The vehicle 140 can receive the WPS initiation signal 180 and respond in a variety of ways. For example, in some embodiments, the vehicle 140 can operate a vehicular feedback mechanism (not shown), indicating it has received a WPS initiation signal. In certain embodiments, a user can manipulate the third manual interface device 146 of the vehicle 140 to transmit a WPS response signal 184, continuing the WPS procedure.

Additionally, in some embodiments, the vehicle 140 can transmit a WPS notification signal 182. The key fob 110 can operate the first feedback device 120 upon receiving the WPS notification signal 182, thereby notifying a nearby user of reception by the vehicle of a WPS initiation signal 180. The user can manipulate the first and/or second manual interface devices 116, 118 as described above to transmit an acknowledgement signal 186 from the key fob 110 to the vehicle 140. In response to the acknowledgment signal 186, the vehicle 140 can transmit a WPS response signal 184, thereby allowing a user to respond in at least two different ways to the reception of a WPS initiation signal 180 by the vehicle 140.

To ensure the vehicle 140 has received a WPS initiation signal 180 from an intended source, the acknowledgement signal 186 can serve as the confirmation signal described above. Accordingly, preferably a user can manipulate the key fob 110 to transmit the acknowledgment signal 186 after confirming through feedback from the vehicle 140 and/or wireless access point 170 that the vehicle 140 is establishing a WPS session with the intended wireless access point 170 and not a foreign wireless access point. Such confirmation can cause the vehicle 140 to continue the WPS session or consider the conclusion of the most recent WPS session a success, and save the exchanged security information as described above.

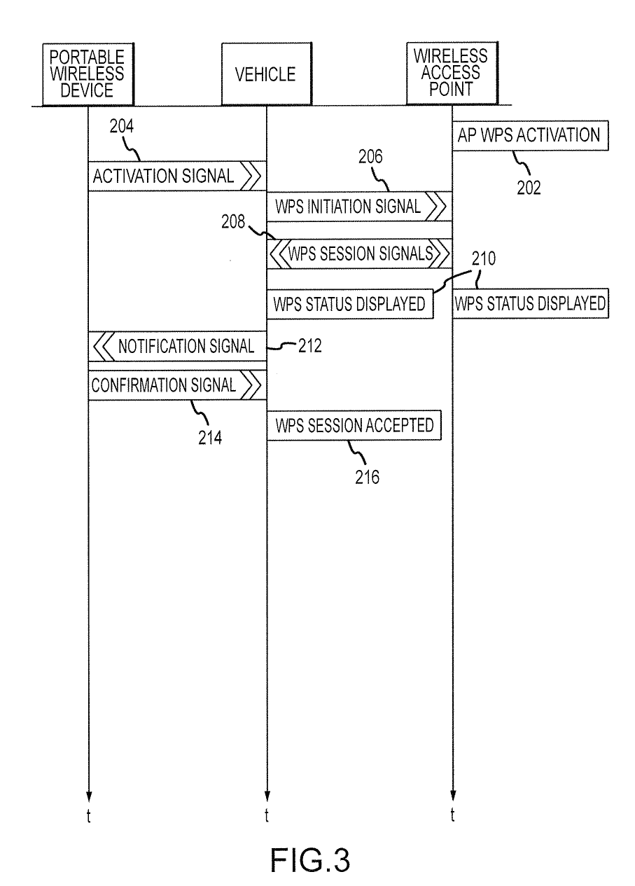

FIG. 3 illustrates a sequence 200 of steps of a method of initializing secure wireless communication. The various tasks performed in connection with sequence 200 may be performed by software, hardware, firmware, or any combination thereof. For illustrative purposes, the following description of sequence 200 may refer to elements mentioned above in connection with FIGS. 1 and 2. In practice, portions of sequence 200 may be performed by different elements of the described system, e.g., the first wireless transceiver 12, first control system 14, first manual interface device 16, second wireless transceiver 42, or second control system 44.

It should be appreciated that sequence 200 may include any number of additional or alternative tasks, the tasks shown in FIG. 3 need not be performed in the illustrated order, and sequence 200 may be incorporated into a more comprehensive procedure or sequence having additional functionality not described in detail herein. Consequently, such additional steps, in sequence 200 are not present in some embodiments, while other embodiments can comprise some or all of the illustrated steps as well as permutations and/or other steps described herein, though not illustrated.

In at least one embodiment, one sequence 200 of establishing secure communication between a vehicle and a wireless access point can comprise establishing an encrypted channel between them. As shown in FIG. 3, signals can be exchanged between various sources and devices with increasing time t. Thus, signals occur in succession moving down the diagram. Direction of signal transmission direction is indicated by an arrow. Some events or actions are also illustrated without directional indicators.

In the sequence illustrated in FIG. 3, a portable wireless device, such as a key fob, is used to initiate WPS between a vehicle and a wireless access point, thereby securing wireless communication between them, and confirm the WPS session took place with the intended wireless access point, causing the vehicle to retain and implement the result of the WPS session. A manual interface device of the wireless access point can be manipulated 202 by a user, causing it to open a WPS session, in accordance with the WPS protocol. Other protocols can be used for exchanging secure credentials as well. A user can then manipulate the portable wireless device, which can be adapted to transmit an activation signal 204 in response to such manipulation. Other manipulations, such as pressing different buttons or the same button in a different pattern, or in conjunction with others, can cause the vehicle to perform a vehicular action, as described above. As shown, the vehicle can receive the activation signal 204 and transmit a WPS initiation signal 206 in response.

The wireless access point can receive the WPS initiation signal 206. In some embodiments, the vehicle and wireless access point can exchange signals 208 as appropriate to complete a WPS session in response to reception of the WPS initiation signal 206. Such signals 208 can originate with either device, as appropriate to the session. In some embodiments, the wireless activation point can comprise a feedback device which activates in response to receiving the WPS initiation signal 204. In certain embodiments, the wireless access point can be configured to continue the WPS session signals 208 only when a manual interface device of the access point is manipulated within a certain, predetermined time interval after reception of the WPS initiation signal 206.

In certain embodiments, the user can transmit the activation signal 204 prior to manipulating 202 a manual interface device of the wireless access device. Under those circumstances, the vehicle can transmit the WPS initiation signal 204 as shown. The WPS initiation signal 204 can be repeated a pre-set number of times over an interval of time, such as once every 100 milliseconds for two minutes, once every second for five minutes, and so on, until either the interval of time has expired, or the wireless access point responds, resulting in the WPS session signals 208. The wireless access point can respond to the wireless communications from the vehicle, entering into the WPS session, as a result of a user manipulating 202 the interface device after the WPS initiation signal 206 has been received by the access point.

The wireless access point can activate its feedback device in response to receiving a WPS initiation signal 208 prior to manipulation 202 of its own interface device. Accordingly, a user can determine, through audible, visual, or other means of feedback, such as a signal supplied to a computer communicating with the wireless access point, that the wireless access point is receiving a WPS initiation signal 206.

In some embodiments, the vehicle and/or wireless access point can display the status 210 of the WPS session after completion of the WPS session signals 208. The vehicle can temporarily store the exchanged security credentials pending any further input, as described below. Accordingly, a user in contact with either the vehicle or wireless access point can be informed of the successful completion of the WPS session. In some embodiments, the vehicle can transmit a notification signal 212 to the key fob conveying information indicative of the successful completion of the WPS session. Some key fobs can be adapted to provide feedback to the user indicating success of the WPS session in response to receiving the notification signal 212. In some embodiments, the signal can be sent as well as display of status 210 at the vehicle and wireless access point.

After verifying the vehicle completed, transacted, or exchanged security information through a WPS session with the intended wireless access point, the user can manipulate the key fob to transmit the wireless network security protocol confirmation signal 214. Such verification can be accomplished though inspection of the wireless access point, feedback therefrom, or in cooperation with a networked device adapted to provide such information, such as a personal computer or other computing device. Transmission of the confirmation signal 214 can require manipulation of at least two buttons of the key fob, and preferably either in a pattern, sequence, or other distinctive method of operation to avoid accidental transmission of the confirmation signal 214.

The confirmation signal 214 can be received by the vehicle. In response, the vehicle can accept 216, confirm, retain and/or register the outcome of the WPS session as having been successfully completed. In some embodiments, the vehicle can also operate a feedback device coupled to the vehicle in response to receiving the confirmation signal 214.

The vehicle can store the security information generated and/or exchanged during the WPS session and use it in future secure communication with the wireless access point as a result of accepting the WPS session. If the vehicle does not receive a conformation signal 214 within a predetermined time, such as 10 seconds, 30 seconds, one minute, five minutes, or so on, the vehicle can remove the WPS session information, not saving the exchanged or derived security information.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A wireless communication system for a vehicle comprising:
a portable wireless device comprising first and second manual interface devices and adapted to transmit a wireless network security protocol confirmation signal in response to manipulation of the first and second manual interface devices; and
an onboard wireless communication device for the vehicle, adapted to accept a Wi-Fi Protected Setup (WPS) session outcome in response to receiving the wireless network security protocol confirmation signal.

2. The wireless communication system of claim 1, wherein the portable wireless device is further adapted to transmit an activation signal in response to manipulation of the first manual interface device.

3. The wireless communication system of claim 2, wherein the onboard wireless communication device is further adapted to transmit a WPS initiation signal in response to receiving the wireless network security protocol activation signal.

4. The wireless communication system of claim 1, wherein the first manual interface device comprises a first button, the second manual interface device comprises a second button, and the portable wireless device is adapted to transmit the wireless network security protocol confirmation signal in response to sustained activation of the first button and activation of the second button during the sustained activation of the first button.

5. The wireless communication system of claim 4, wherein the portable wireless device is further adapted to transmit a vehicular operation request signal in response to activation of only the second button.

6. The wireless communication system of claim 5, wherein the vehicle is adapted to initiate a vehicular operation in response to receiving the vehicular operation request signal.

7. The wireless communication system of claim 6, wherein the vehicle further comprises a door and the requested vehicular operation comprises at least one of locking the door and unlocking the door.

8. The wireless communication system of claim 6, wherein the vehicle further comprises a theft deterrent system and the requested vehicular operation comprises at least one of activating the theft deterrent system of the vehicle and deactivating the theft deterrent system.

9. The wireless communication system of claim 1, wherein the onboard wireless communication device further comprises a feedback device, the onboard wireless communication device further adapted to operate the feedback device in response to receiving wireless network security protocol confirmation signal.

10. The wireless communication system of claim 1, wherein the portable wireless device comprises a key fob.

11. A method of confirming establishment of secure wireless network communication between a vehicle and a wireless access point, the method comprising:
receiving a wireless network security protocol confirmation signal at the vehicle from a key fob associated with the vehicle; and
accepting an outcome of a Wi-Fi Protected Setup (WPS) session between the vehicle and the wireless access point at the vehicle in response to receiving the wireless network security protocol confirmation signal.

12. The method of claim 11, further comprising operating a feedback device of the vehicle in response to receiving the wireless network security protocol confirmation signal.

13. The method of claim 11, further comprising transmitting a WPS initiation signal in response to receiving an activation signal from the key fob.

14. The method of claim 13, further comprising activating a feedback device of the vehicle in response to receiving the activation signal.

15. The method of claim 14, activating a feedback device of the vehicle comprises emitting at least one of an audible or visual signal.

16. The method of claim 11, wherein the vehicle is adapted to perform a vehicular operation in response to receiving a vehicular operation request signal from the key fob.

17. The method of claim 16, wherein performing a vehicular operation comprises at least one of locking and unlocking a door of the vehicle.

18. A method of establishing secure wireless communication between a vehicle and a wireless access point comprising:
receiving an activation signal at the vehicle;
transmitting a wireless network security protocol initiation signal from the vehicle in response to the activation signal;
performing a wireless network security protocol session from the vehicle in response to a wireless network security protocol signal from the wireless access point; and
operating a feedback device of the vehicle after completion of the wireless network security protocol session; and
retaining the outcome of the wireless network security protocol session in response to receiving a confirmation signal from a key fob associated with the vehicle.

19. The method of claim 18, further comprising receiving a wireless network security protocol confirmation signal from a key fob associated with the vehicle, the wireless network security protocol signal confirmation signal being generated in response to the notification signal.

20. The method of claim 19, further comprising operating a feedback device of the vehicle in response to receiving the wireless network security protocol confirmation signal.
